(19) United States
(12) Patent Application Publication
(10) Pub. No.: US 2022/0342407 A1
(43) Pub. Date: Oct. 27, 2022

(54) IRREGULARITY DETECTION SYSTEM, IRREGULARITY DETECTION METHOD, AND COMPUTER READABLE MEDIUM

(71) Applicant: Mitsubishi Electric Corporation, Tokyo (JP)

(72) Inventors: Masaaki AOKI, Tokyo (JP); Masahiko SHIBATA, Tokyo (JP)

(73) Assignee: Mitsubishi Electric Corporation, Tokyo (JP)

(21) Appl. No.: 17/860,666

(22) Filed: Jul. 8, 2022

Related U.S. Application Data
(63) Continuation of application No. PCT/JP2020/009005, filed on Mar. 3, 2020.

(51) Int. Cl. G05B 23/02

(52) U.S. Cl. CPC G05B 23/0243; G05B 23/0224

(57) ABSTRACT

An irregularity detection apparatus (100) converts a multi-valued-signal value of each of one or more multi-valued-signals at each time point into a binary-signal-value group. The irregularity detection apparatus calculates a forecast-signal-value group at a subject time point by computing a forecast model with use of, as input, a past-signal-value group which is a collection of a binary-signal value of each of one or more binary signals at each past time point and the binary-signal-value group of each of the one or more multi-valued signals at each past time point. The irregularity detection apparatus compares with the forecast-signal-value group, a collection of the binary-signal value of each of the one or more binary signals at the subject time point and the binary-signal-value group of each of the one or more multi-valued signals at the subject time point, and determines a state of a subject system (220) at the subject time point.

### CROSS REFERENCE TO RELATED APPLICATIONS

This application is a Continuation of PCT International Application No. PCT/JP2020/009005 filed on Mar. 3, 2020, which is hereby expressly incorporated by reference into the present application.

### TECHNICAL FIELD

The present disclosure relates to a technique of detecting irregularity in a subject of monitoring.

### BACKGROUND ART

In a conventional factory, when trouble such as a stop of a production line happens, a maintenance worker of the factory specifies a cause of the trouble based on knowledge and experience and properly deals with the trouble.

However, in many cases, it is difficult to specify the cause of the trouble in an enormous amount of operation data and a complicated program, and solve the trouble early.

Further, it is difficult to create a condition setting and a program which can specify the cause of the trouble comprehensively, within a realistic number of man-hours.

Patent Literature 1 discloses a system for a maintenance worker to acquire, without a comprehensive condition setting, a clue for specifying a sensor or a program which is the cause of the trouble.

The system automatically detects an irregular chronological change of a binary signal which represents an on-state and an off-state of the sensor.

### CITATION LIST

### Patent Literature

Patent Literature 1: WO2019-003404A

### SUMMARY OF INVENTION

### Technical Problem

Occasionally, in order to monitor an operation status of a facility, detection of the irregular chronological change of a multi-valued signal is necessary in addition to detection of that of the binary signal.

The irregular chronological change of the multi-valued signal includes, in addition to a case where a value of the multi-valued signal becomes an irregular value, a case where a value of the multi-valued signal does not correspond to a change in another signal whereas the value of the multi-valued signal is a regular value. For the latter case, it is necessary to distinguish, taking a relation between the binary signal and the multi-valued signal into consideration.

The system of Patent Literature 1 can detect an irregular change of the binary signal. However, the irregular change of the multi-valued signal is not detected because the irregular change of the multi-valued signal is not subject to detection.

The present disclosure aims to enable detecting irregularity in a subject of monitoring, taking a multi-valued signal into consideration.

### Solution to Problem

An irregularity detection system according to the present disclosure, for detecting irregularity of a subject system based on a binary-signal value of each of one or more binary signals and a multi-valued-signal value of each of one or more multi-valued signals, includes:

a conversion unit to convert the multi-valued-signal value of each of the one or more multi-valued-signals at each time point into a binary-signal-value group which is one or more binary-signal values;

a forecast unit to calculate a forecast-signal-value group at a subject time point by computing a forecast model with use of, as input, a past-signal-value group which is a collection of the binary-signal value of each of the one or more binary signals at each time point before the subject time point and the binary-signal-value group of each of the one or more multi-valued signals at each time point before the subject time point; and

a determination unit to compare with the forecast-signal-value group, a subject signal-value group which is a collection of the binary-signal value of each of the one or more binary signals at the subject time point and the binary-signal-value group of each of the one or more multi-valued signals at the subject time point, and determine whether or not a state of the subject system at the subject time point is regular, based on a comparison result.

### Advantageous Effects of Invention

According to the present disclosure, it is possible to detect irregularity in a subject of monitoring (subject system), taking a multi-valued signal into consideration.

### BRIEF DESCRIPTION OF DRAWINGS

FIG. 1 is a configuration diagram of an irregularity detection system 200 according to a first embodiment.

FIG. 2 is a configuration diagram of an irregularity detection apparatus 100 according to the first embodiment.

FIG. 3 is a configuration diagram of a model generation unit 110 according to the first embodiment.

FIG. 4 is a configuration diagram of an irregularity detection unit 120 according the first embodiment.

FIG. 5 is an outline diagram of a model generation process (S100) according to the first embodiment.

FIG. 6 is a flowchart of the model generation process (S100) according to the first embodiment.

FIG. 7 is a flowchart of a threshold-value-group calculation process (S130) according to the first embodiment.

FIG. 8 is an outline diagram of the threshold-value-group calculation process (S130) according to the first embodiment.

FIG. 9 is a flowchart of a conversion process (S140) according to the first embodiment.

FIG. 10 is a flowchart of step S145 according to the first embodiment.

FIG. 11 is an outline diagram of the conversion process (S140) according to the first embodiment.

FIG. 12 is an outline diagram of an irregularity detection process (S200) according to the first embodiment.

FIG. 13 is a flowchart of the irregularity detection process (S200) according to the first embodiment.

FIG. 14 is a flowchart of a conversion process (S220) according to the first embodiment.

FIG. 15 is a configuration diagram of a model generation unit 110 according to a second embodiment.

FIG. 16 is a flowchart of a model generation process (S100B) according to the second embodiment.

FIG. 17 is a flowchart of a conversion process (S130B) according to the second embodiment.

FIG. 18 is a flowchart of step S135B according to the second embodiment.

FIG. 19 is an outline diagram of the conversion process (S130B) according to the second embodiment.

FIG. 20 is a flowchart of an irregularity detection process (S200B) according to the second embodiment.

FIG. 21 is a flowchart of a conversion process (S220B) according to the second embodiment.

FIG. 22 is a hardware configuration diagram of the irregularity detection apparatus 100 according to the embodiments.

### DESCRIPTION OF EMBODIMENTS

In the embodiments and the drawings, the same reference numerals are assigned to the same elements or corresponding elements. Descriptions of elements assigned with the same reference numerals as the described elements will be omitted or simplified as appropriate. Arrows in the drawings mainly indicate flows of data or flows of processes.

### First Embodiment

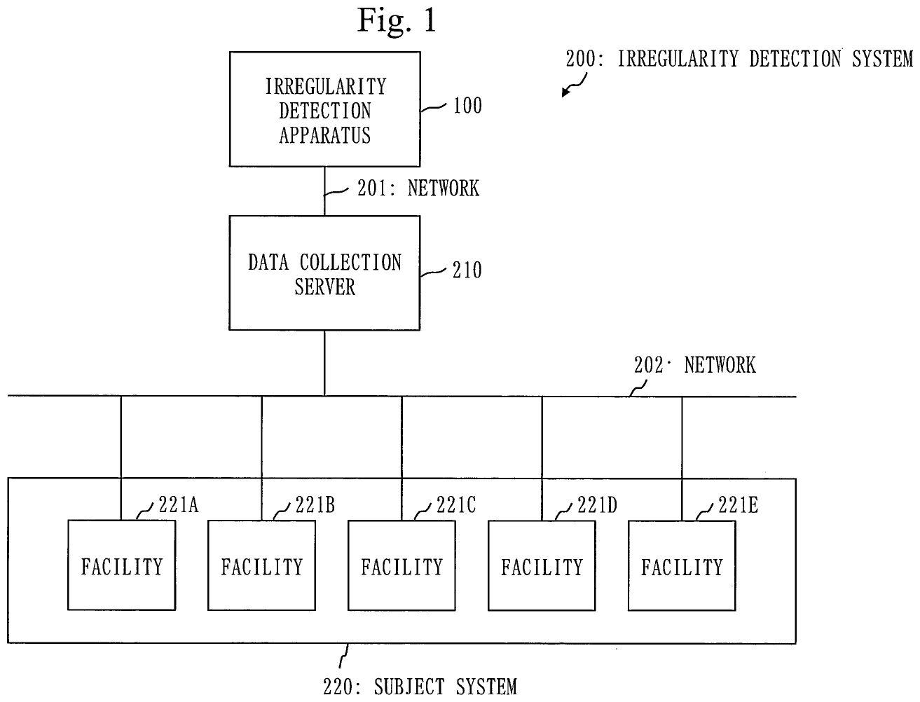

An irregularity detection system 200 will be described based on FIGS. 1 to 14.

***Description of Configuration***

Based on FIG. 1, a configuration of the irregularity detection system 200 will be described.

The irregularity detection system 200 includes an irregularity detection apparatus 100, a data collection server 210, and a subject system 220.

The irregularity detection apparatus 100 communicates with the data collection server 210 via a network 201.

The data collection server 210 communicates with the subject system 220 via a network 202.

The subject system 220 is a system subject to monitoring. For example, the subject system 220 is a factory line.

The subject system 220 includes one or more facilities 221. In FIG. 1, the subject system 220 includes five facilities (221A to 221E).

Each facility 221 includes one or more devices. For example, each facility 221 includes a sensor, a robot, and the like.

Each facility 221 outputs data which indicates an operation status at each time point. The data which indicates the operation status at each time point is referred to as “operation data”. The operation data is also referred to as collection data, signal data, or state-signal data.

The operation data includes one or more binary-signal values and one or more multi-valued-signal values.

The binary-signal value is a value that a binary signal indicates. For example, a signal output from the sensor is the binary signal which indicates a state of the sensor by two values of “on” and “off”.

The multi-valued-signal value is a value that a multi-valued signal indicates. For example, a signal output from a robot hand is the multi-valued signal which indicates torque of the robot hand by more values than the two values.

When the binary signal and the multi-valued signal are not distinguished from each other, each one is referred to as a “state signal”.

When the binary-signal value and the multi-valued-signal value are not distinguished from each other, each one is referred to as a “state-signal value” or a “signal value”.

The data collection server 210 is a computer which has a processor, a storage device, a communication device, and the like. “Server” is also referred to as “server device”.

The data collection server 210 collects from each facility 221, the operation data which is at each time point, and accumulates the collected pieces of operation data.

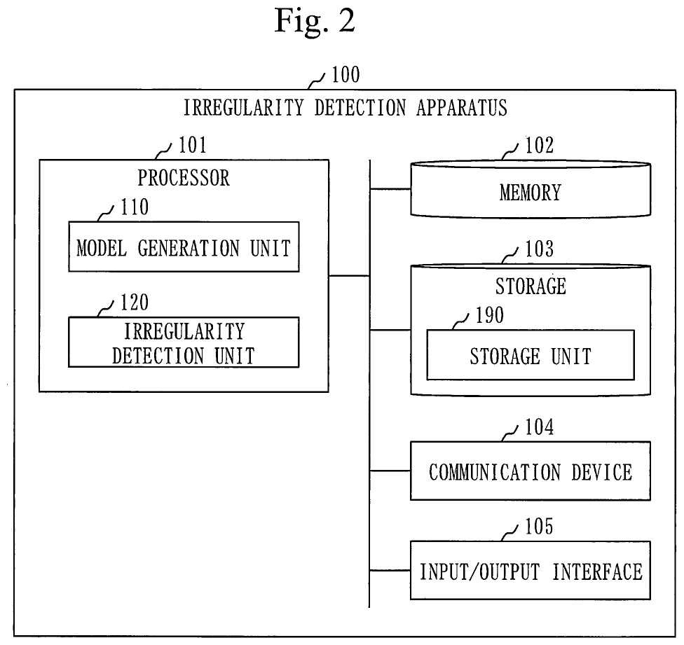

Based on FIG. 2, a configuration of the irregularity detection apparatus 100 will be described.

The irregularity detection apparatus 100 is a computer which includes pieces of hardware such as a processor 101, a memory 102, a storage 103, a communication device 104, and an input/output interface 105. These pieces of hardware are connected to each other via a signal line.

The processor 101 is an IC that performs a computation process, and controls other pieces of hardware. For example, the processor 101 is a CPU.

IC stands for Integrated Circuit.

CPU stands for Central Processing Unit.

The memory 102 is a volatile or non-volatile storage device. The memory 102 is also referred to as a main storage device or a main memory. For example, the memory 102 is a RAM. Data stored in the memory 102 is stored in the storage 103 as necessary.

RAM stands for Random Access Memory.

The storage 103 is a non-volatile storage device. The storage 103 is also referred to as an auxiliary storage device. For example, the storage 103 is an HDD. Data stored in the storage 103 is loaded into the memory 102 as necessary.

HDD stands for Hard Disk Drive.

The communication device 104 functions as a receiver and a transmitter. For example, the communication device 104 is a communication board.

The input/output interface 105 is a port to which an input device and an output device are connected. For example, the input/output interface 105 is a USB terminal, the input devices are a keyboard and a mouse, and the output device is a display.

USB stands for Universal Serial Bus.

The irregularity detection apparatus 100 includes elements such as a model generation unit 110 and an irregularity detection unit 120. These elements are realized by software.

The storage 103 stores an irregularity detection program for causing a computer to function as the model generation unit 110 and the irregularity detection unit 120. The irregularity detection program is loaded into the memory 102 and executed by the processor 101.

The storage 103 further stores an OS. At least a part of the OS is loaded into the memory 102 and executed by the processor 101.

The processor 101 executes the irregularity detection program while executing the OS.

OS stands for Operating System.

Input/output data of the irregularity detection program is stored in a storage unit 190.

The storage 103 functions as the storage unit 190. However, the storage devices such as the memory 102, a register in the processor 101, and a cash memory in the processor 101 may function as the storage unit 190 in place of the storage 103 or together with the storage 103.

The irregularity detection apparatus 100 may include a plurality of processors which substitute for the processor 101. The plurality of processors share a function of the processor 101.

The irregularity detection program can be recorded (stored) in a non-volatile recording medium such as an optical disc or a flash memory, in a computer-readable manner.

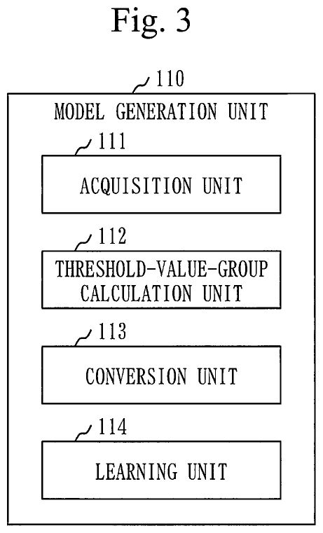

Based on FIG. 3, a configuration of the model generation unit 110 will be described.

The model generation unit 110 includes elements such as an acquisition unit 111, a threshold-value-group calculation unit 112, a conversion unit 113, and a learning unit 114. A function of each element will be described later.

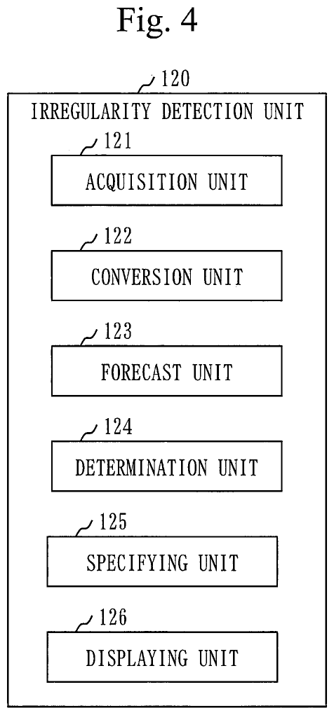

Based on FIG. 4, a configuration of the irregularity detection unit 120 will be described.

The irregularity detection unit 120 includes elements such as an acquisition unit 121, a conversion unit 122, a forecast unit 123, a determination unit 124, a specifying unit 125, and a displaying unit 126. A function of each element will be described later.

***Description of Operation***

A procedure of operation of the irregularity detection system 200 (especially, operation of the irregularity detection apparatus 100) is equivalent to an irregularity detection method. Further, a procedure of the operation of the irregularity detection apparatus 100 is equivalent to a procedure of processes by the irregularity detection program.

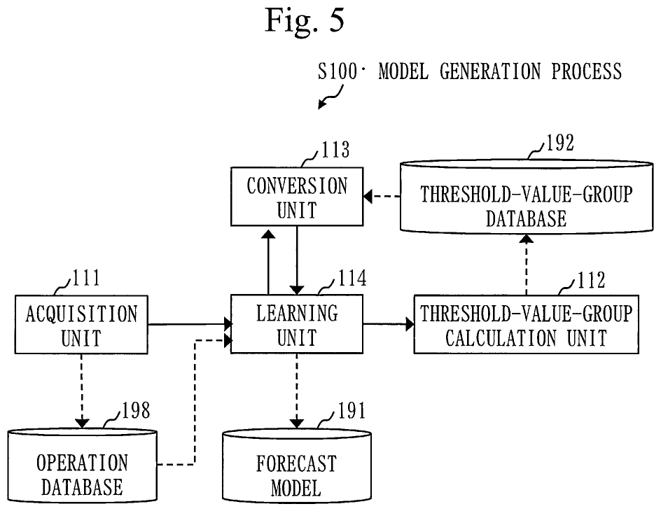

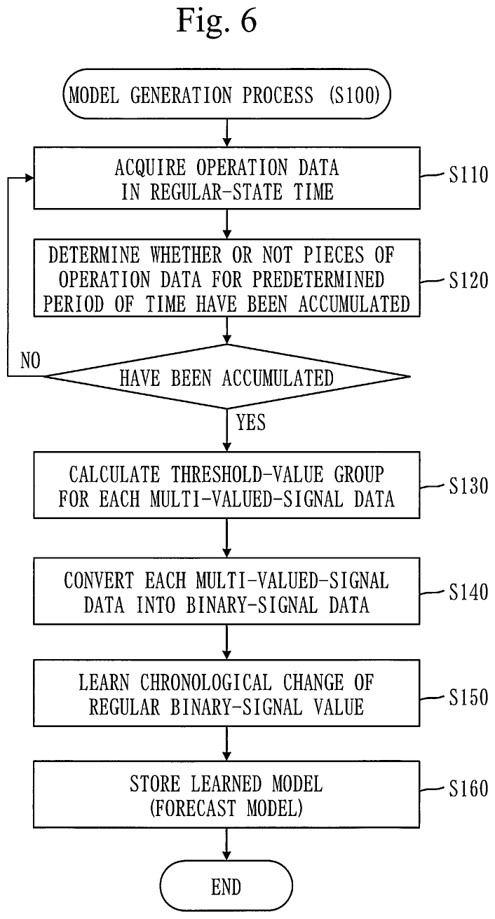

Based on FIGS. 5 and 6, a model generation process (S100) will be described.

In FIG. 5, solid-line arrows represent call relations between the elements, and dotted-line arrows represent flows of pieces of data to the elements.

The model generation process (S100) is a process for generating a forecast model 191.

The forecast model 191 is a learned model for forecasting a signal value of each state signal. The forecast model 191 is also referred to as a normal model. A forecast signal value of each state signal at a next time point after a subject time point is calculated by computing the forecast model 191 with the use of a signal value of each state signal before the subject time point, as input. The forecast signal value is a signal value which is forecasted.

In step S110, the acquisition unit 111 acquires operation data in regular-state time and stores the acquired operation data in the storage unit 190.

The operation data in the regular-state time is operation data collected when the subject system 220 is in a regular state.

The operation data in the regular-state time is acquired as follows.

A state of the subject system 220 is the regular state.

The data collection server 210 collects the operation data from each facility 221 at each time point and stores the collected operation data. The stored operation data is the operation data in the regular-state time.

The acquisition unit 111 receives new operation data in the regular-state time from the data collection server 210 at each time point, and stores the received operation data in the storage unit 190. In other words, the acquisition unit 111 copies the new operation data in the regular-state time from the data collection server 210 into the storage unit 190.

Pieces of operation data in the regular-state time are accumulated in the storage unit 190 by repeating step S110. The accumulated pieces of operation data in the regular-state time, that is, a collection of the pieces of operation data in the regular-state time, are referred to as an “operation database 198”.

In step S120, the acquisition unit 111 determines whether or not pieces of operation data in the regular-state time for a predetermined period of time have been accumulated.

For example, the acquisition unit 111 selects the oldest operation data and the latest operation data from the operation database 198, and calculates a length of time from a time point of the oldest operation data until a time point of the latest operation data. Then, the acquisition unit 111 compares the calculated length of time with a threshold value. If the calculated length of time is equal to or larger than the threshold value, the acquisition unit 111 determines that the pieces of operation data for the predetermined period of time have been accumulated. The threshold value is a predetermined length of time. The length of time of the threshold value varies depending on a characteristic of the subject system 220. The length of time of the threshold value is approximately from some hours to some weeks.

If the pieces of operation data for the predetermined period of time have been accumulated, the process proceeds to step S130.

If the pieces of operation data for the predetermined period of time have not been accumulated, the process proceeds to step S110.

The operation database 198 includes the operation data at each time point. That is, the operation database 198 includes the signal value, at each time point, of each state signal.

Data indicating the signal value, at each time point, of the binary signal, that is chronological data of the binary signal is referred to as “binary-signal data”.

Data indicating the signal value, at each time point, of the multi-valued signal, that is chronological data of the multi-valued signal is referred to as “multi-valued-signal data”.

When the binary-signal data and the multi-valued-signal data are not distinguished from each other, each one is referred to as “state-signal data”.

In step S130, the learning unit 114 reads the operation database 198 and calls the threshold-value-group calculation unit 112.

The threshold-value-group calculation unit 112 calculates a threshold-value group for each multi-valued-signal data included in the operation database 198. The threshold-value group is one or more threshold values used for converting each multi-valued-signal value in the multi-valued-signal data into one or more binary-signal values (binary-signal-value group).

The threshold-value-group calculation unit 112 stores in the storage unit 190, the threshold-value group which is for each multi-valued-signal.

The stored threshold-value groups, that is, a collection of the threshold-value groups, are referred to as a “threshold-value-group database 192”.

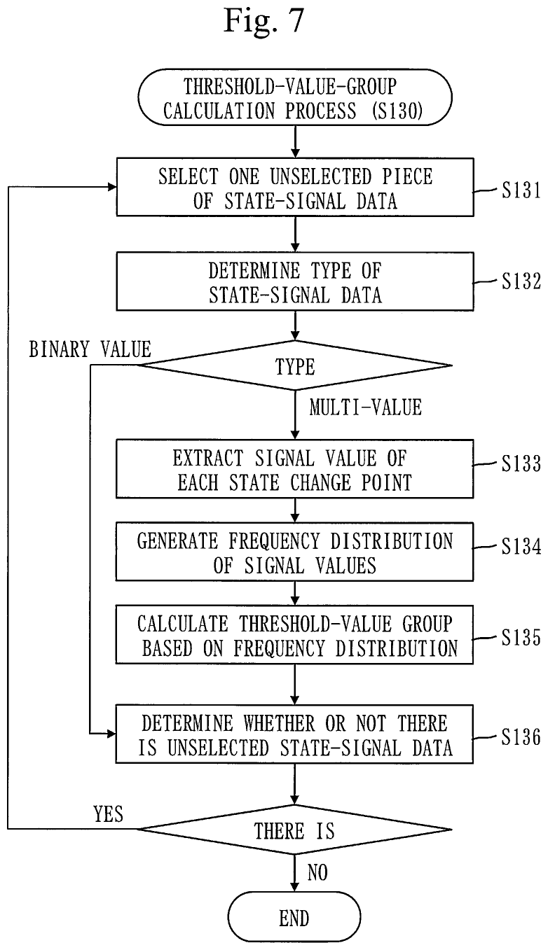

Based on FIG. 7, a procedure of a threshold-value-group calculation process (S130) will be described.

In step S131, the threshold-value-group calculation unit 112 selects one unselected piece of state-signal data from the operation database 198. The selected state-signal data is referred to as “subject signal data”.

In step S132, the threshold-value-group calculation unit 112 determines a type of the subject signal data.

For example, each state-signal data is given a type identifier. The type identifier identifies a type of the state-signal data. The threshold-value-group calculation unit 112 determines the type of the subject signal data by referring to the type identifier given to the subject signal data.

If the subject signal data is the binary-signal data, the process proceeds to step S136.

If the subject signal data is the multi-valued-signal data, the process proceeds to step S133.

In step S133, the threshold-value-group calculation unit 112 extracts a signal value of each of one or more state change points from the subject signal data. The state change point is a time point when a change tendency of the multi-valued signal changes, that is a time point when a state of the facility 221 changes. For example, the multi-valued signal which is in a rising tendency until the state change point lowers or becomes constant after the state change point. Further, the multi-valued signal which has been in a lowering tendency until the state change point rises or becomes constant after the state change point.

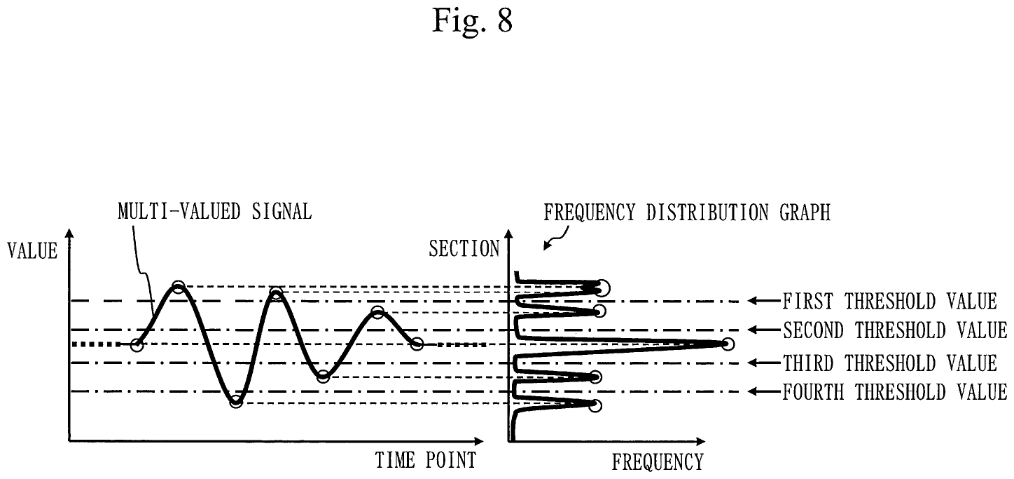

FIG. 8 illustrates a specific example of the multi-valued signal.

Each peak of the multi-valued signal is given a circle mark. The signal value of a part given the circle mark is the signal value of the state change point.

Returning to FIG. 7, the descriptions will be continued from step S134.

In step S134, the threshold-value-group calculation unit 112 generates a frequency distribution of the extracted signal values.

For example, the threshold-value-group calculation unit 112 generates a frequency distribution graph as illustrated in FIG. 8. A “section” means a range of the signal value.

In step S135, the threshold-value-group calculation unit 112 calculates the threshold-value group which is for the subject signal, based on the generated frequency distribution.

More specifically, the threshold-value-group calculation unit 112 selects each peak from the frequency distribution and specifies a signal value corresponding to each peak. Then, the threshold-value-group calculation unit 112 calculates for each range between two peaks, a value between the signal value corresponding to one peak and the signal value corresponding to the other peak. Each calculated value is a threshold value. For example, when the signal value corresponding to a first peak is “2” and the signal value corresponding to a second peak is “4”, “3” (=(2+4)/2) is the threshold value.

The threshold-value-group calculation unit 112 stores the calculated threshold-value group in the storage unit 190.

FIG. 8 illustrates a specific example of the frequency distribution graph.

Each peak in the frequency distribution graph is given a circle mark.

The threshold-value-group calculation unit 112 calculates four threshold values separating five peaks from each other, for the frequency distribution graph in FIG. 8.

Returning to FIG. 7, the descriptions will be continued from step S136.

In step S136, the threshold-value-group calculation unit 112 determines whether or not there is an unselected state-signal data in the operation database 198.

If there is the unselected state-signal data, the process proceeds to step S131.

If there is no unselected state-signal data, the process ends.

Supplementary descriptions of the threshold-value-group calculation process (S130) will be given.

The frequency distribution may be a frequency distribution of a value (differential value) obtained by differentiating each multi-valued-signal value. In this case, the threshold-value-group calculation unit 112 operates as follows.

In step S133, the threshold-value-group calculation unit 112 differentiates each multi-valued-signal value in the multi-valued-signal data and extracts a differential value of each state change point from the differentiated multi-valued-signal data. The differentiation may be executed to any degree.

In step S134, the threshold-value-group calculation unit 112 generates the frequency distribution of the extracted differential values.

Returning to FIG. 6, the descriptions will be continued from step S140.

In step S140, the learning unit 114 calls the conversion unit 113.

The conversion unit 113 converts for each multi-valued-signal data, each multi-valued-signal value in the multi-valued-signal data into the binary-signal value, using the threshold-value group. That is, the conversion unit 113 converts each multi-valued-signal data into the binary-signal data.

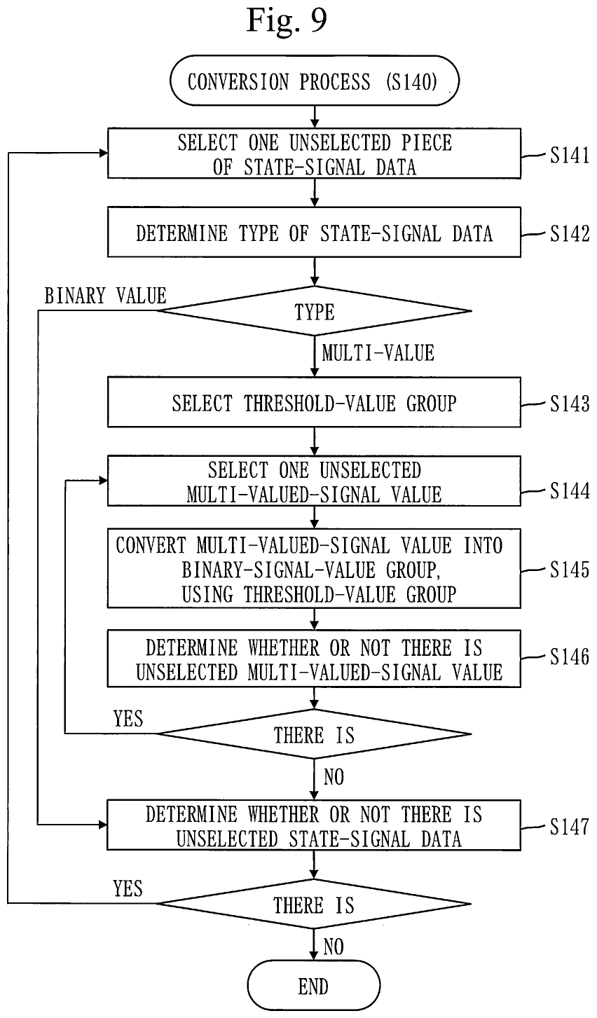

Based on FIG. 9, a procedure of a conversion process (S140) will be described.

In step S141, the conversion unit 113 selects one unselected piece of state-signal data from the operation database 198. The selected piece of state-signal data is referred to as “subject signal data”. The state signal corresponding to the subject signal data is referred to as a “subject signal”.

In step S142, the conversion unit 113 determines a type of the subject signal data. A determination method is the same as the method in step S132 (see FIG. 7).

If the subject signal data is the binary-signal data, the process proceeds to step S147.

If the subject signal data is the multi-valued-signal data, the process proceeds to step S143.

In step S143, the conversion unit 113 selects the threshold-value group which is for the subject signal, from the threshold-value-group database 192. The selected threshold-value group is referred to as a “subject threshold-value group”.

In step S144, the conversion unit 113 selects one unselected multi-valued-signal value from the subject signal data. The selected multi-valued-signal value is referred to as a “subject signal value”.

In step S145, the conversion unit 113 converts the subject signal value into the binary-signal-value group, using the subject threshold-value group. The binary-signal-value group is one or more binary-signal values.

Specifically, the conversion unit 113 converts for each threshold value in the subject threshold-value group, the subject signal value into the binary-signal value which indicates a magnitude-comparison relation between the subject signal value and the threshold value.

Details of step S145 will be described later.

In step S146, the conversion unit 113 determines whether or not there is an unselected multi-valued-signal value in the subject signal data.

If there is the unselected multi-valued-signal value, the process proceeds to step S144.

If there is no unselected multi-valued-signal value, the process proceeds to step S147.

In step S147, the conversion unit 113 determines whether or not there is unselected state-signal data in the operation database 198.

If there is the unselected state-signal data, the process proceeds to step S141.

If there is no unselected state-signal data, the process ends.

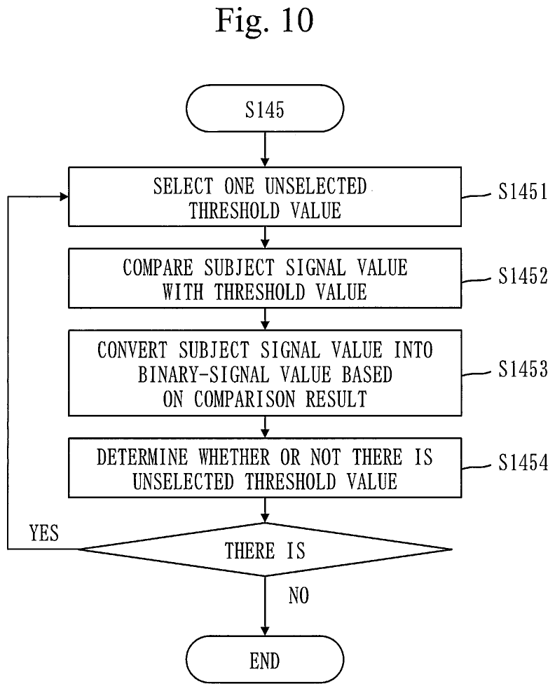

Based on FIG. 10, a procedure of step S145 will be described.

In step S1451, the conversion unit 113 selects one unselected threshold value from the subject threshold-value group. The selected threshold value is referred to as a “subject threshold value”.

In step S1452, the conversion unit 113 compares the subject signal value with the subject threshold value.

In step S1453, the conversion unit 113 converts the subject signal value into the binary-signal value based on a comparison result. The binary-signal value obtained by the conversion indicates by two values, the magnitude-comparison relation between the subject signal value and the subject threshold value.

In step S1454, the conversion unit 113 determines whether or not there is an unselected threshold value in the subject threshold-value group.

If there is the unselected threshold value, the process proceeds to step S1451.

If there is no unselected threshold value, the process ends.

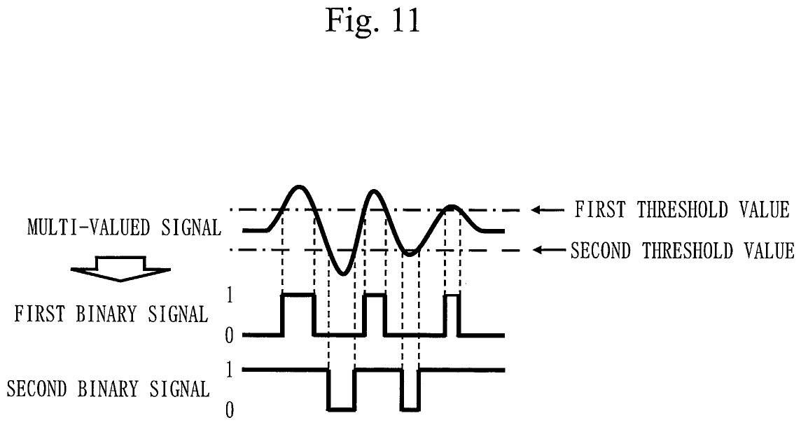

Based on FIG. 11, a conversion method in step S145 will be described.

In FIG. 11, the subject threshold-value group is a pair of a first threshold value and a second threshold value. That is, each of the first threshold value and the second threshold value is the subject threshold value. Further, the signal value, at each time point, of the multi-valued signal is the subject signal value.

In a first binary signal, the binary-signal value at each time point indicates by two values, a magnitude-comparison relation between the subject signal value and the first threshold value.

In a second binary signal, the binary-signal value at each time point indicates by two values, a magnitude-comparison relation between the subject signal value and the second threshold value.

If the subject signal value is equal to or larger than the subject threshold value, the conversion unit 113 converts the subject signal value into “1”. If the subject signal value is smaller than the subject threshold value, the conversion unit 113 converts the subject signal value into “0”.

Returning to FIG. 6, the descriptions will be continued from step S150.

Each binary-signal data accumulated in step S110 is referred to as “collected binary-signal data”. Each binary-signal value in the collected binary-signal data is referred to as a “collected binary-signal value”.

Each binary-signal data acquired in step S140 is referred to as “converted binary-signal data”. Each binary-signal value in the converted binary-signal data is referred to as a “converted binary-signal value”.

A collection of the collected binary-signal data and the converted binary-signal data is referred to as a “regular binary-signal-data group”. A collection of the collected binary-signal value and the converted binary-signal value is referred to as a “regular binary-signal-value group”.

In step S150, the learning unit 114 learns a chronological change of the regular binary-signal value of each state signal with use of the regular binary-signal-data group as input, and generates a learned model. Learning is referred to as machine learning.

The chronological change of the regular binary-signal value means a change of the regular binary-signal value over elapse of time. The chronological change of the regular binary-signal value is also referred to as a regular signal pattern. The chronological change of the regular binary-signal value of each state signal is equivalent to a state change of the subject system 220 in the regular-state time.

A learning method is not limited. For example, the learning unit 114 performs the learning, using a neural network or a Hidden Markov model. By the learning, parameters of the learned model are decided. In the learning using the neural network, parameters are decided such as the number of intermediate layers, weight of each intermediate layer, and a bias value of each intermediate layer.

In step S160, the learning unit 114 stores in the storage unit 190, the learned model generated. The learned model stored is the “forecast model 191”.

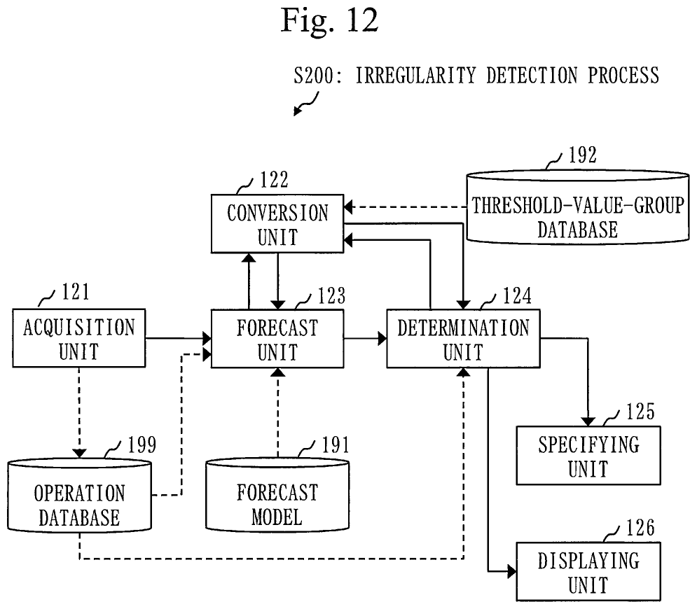

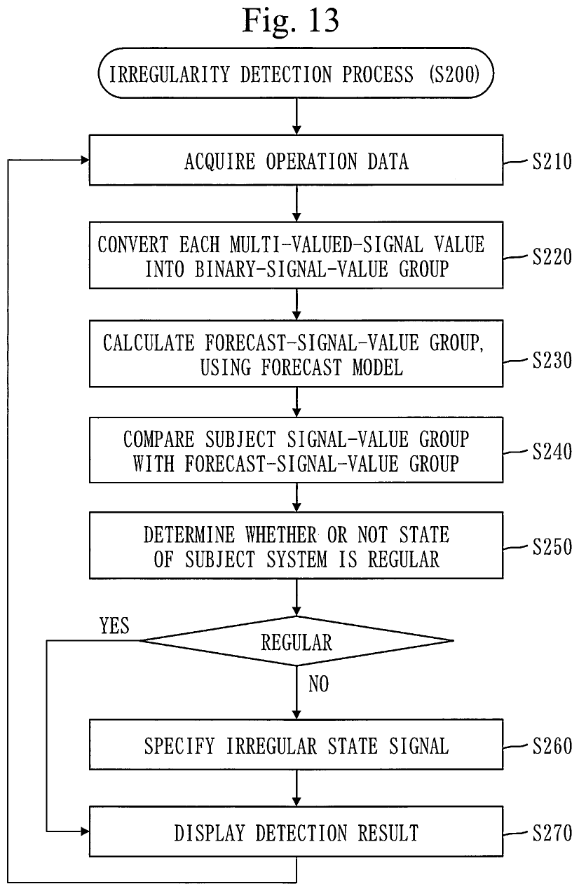

Based on FIGS. 12 and 13, an irregularity detection process (S200) will be described.

In FIG. 12, solid-line arrows represent call relations between the elements, and dotted-line arrows represent flows of pieces of data to the elements.

The irregularity detection process (S200) is a process for detecting the irregularity state of the subject system 220.

In step S210, the acquisition unit 121 acquires the operation data and stores the acquired operation data in the storage unit 190.

The operation data is acquired in the same manner as step S110 (see FIG. 6). However, the acquired operation data is not necessarily the operation data in the regular-state time. That is, the operation data in irregular-state time may be acquired.

The operation data in the irregular-state time is the operation data collected when the subject system 220 is in the irregular state.

The operation data at each time point is stored in the storage unit 190 by repeating step S210. The stored pieces of operation data, that is, a collection of the pieces of operation data, are referred to as an “operation database 199”.

The operation data acquired in step S210 is referred to as “operation data at a subject time point”.

The operation data at the subject time point includes the signal value of each state signal at the subject time point.

In step S220, the forecast unit 123 reads the operation data at the subject time point from the operation database 199 and calls the conversion unit 122.

The conversion unit 122 converts each multi-valued-signal value in the operation data at the subject time point into the binary-signal-value group.

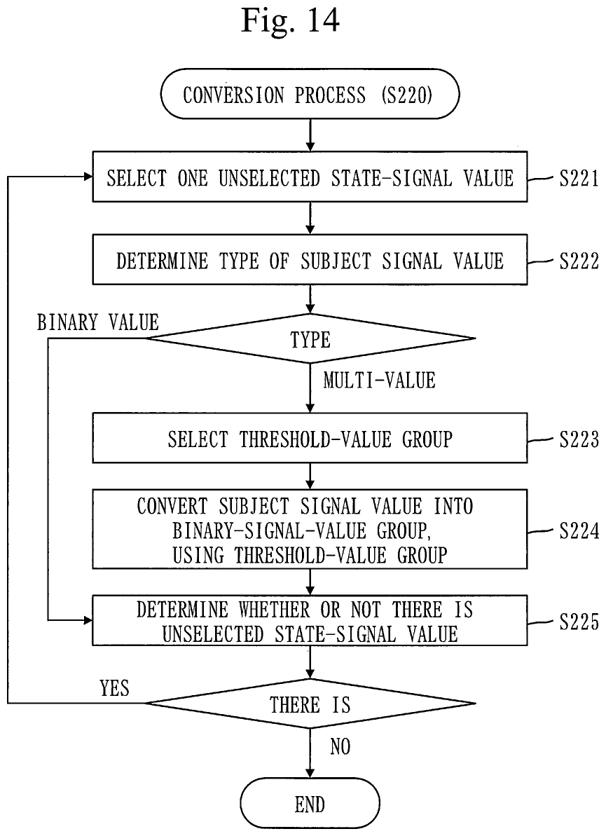

Based on FIG. 14, a procedure of a conversion process (S220) will be described.

In step S221, the conversion unit 122 selects one unselected state-signal value from the operation data at the subject time point. The selected state-signal value is referred to as a “subject signal value”. The state signal corresponding to the subject signal value is referred to as a “subject signal”.

In step S222, the conversion unit 122 determines a type of the subject signal value.

For example, each state-signal value is given a type identifier. The type identifier identifies a type of the state-signal value. The conversion unit 122 determines the type of the subject signal value by referring to the type identifier given to the subject signal value.

If the subject signal value is the binary-signal value, the process proceeds to step S225.

If the subject signal value is the multi-valued-signal value, the process proceeds to step S223.

In step S223, the conversion unit 122 selects a threshold-value group which is for the subject signal, from the threshold-value-group database 192. The selected threshold-value group is referred to as a “subject threshold-value group”.

In step S224, the conversion unit 122 converts the subject signal value into the binary-signal-value group, using the subject threshold-value group.

A conversion method is the same as the method in step S145 (see FIG. 9).

In step S225, the conversion unit 122 determines whether or not there is an unselected state-signal value in the operation data at the subject time point.

If there is the unselected state-signal value, the process proceeds to step S221.

If there is no unselected state-signal value, the process ends.

Returning to FIG. 13, the descriptions will be continued from step S230.

The operation database 199 includes the binary-signal value of each binary signal before the subject time point and the binary-signal-value group of each multi-valued signal before the subject time point.

A collection of the binary-signal value of each binary signal at the subject time point and the binary-signal-value group of each multi-valued signal at the subject time point is referred to as a “subject signal-value group”.

Each time point before the subject time point is referred to as a “past time point”.

A collection of the binary-signal value of each binary signal at each past time point and the binary-signal-value group of each multi-valued signal at each past time point is referred to as a “past-signal-value group”.

In step S230, the forecast unit 123 reads the past-signal-value group from the operation database 199.

The forecast unit 123 computes the forecast model 191 with use of the past-signal-value group as input. Thereby, a forecast-signal-value group at the subject time point is calculated. The forecast-signal-value group is a subject signal-value group which is forecasted.

In step S240, the forecast unit 123 calls the determination unit 124.

The determination unit 124 reads the subject signal-value group from the operation database 199 and compares the subject signal-value group with the forecast-signal-value group.

In step S250, the determination unit 124 determines whether or not the state of the subject system 220 at the subject time point is regular, based on the comparison result.

Specifically, the determination unit 124 calculates an abnormality degree based on the comparison result and compares the abnormality degree with a threshold value.

The threshold value is predetermined. The larger a difference between the subject signal-value group and the forecast-signal-value group is, the larger the abnormality degree is. For example, the determination unit 124 calculates for each state signal, the difference between the subject signal value and the forecast signal value, and calculates a sum of the calculated differences. The calculated sum is the abnormality degree. If the abnormality degree is larger than the threshold value, the determination unit 124 determines that the state of the subject system 220 at the subject time point is irregular.

If the state of the subject system 220 at the subject time point is regular, the process proceeds to step S270.

If the state of the subject system 220 at the subject time point is irregular, the process proceeds to step S260.

In step S260, the determination unit 124 calls the specifying unit 125.

The specifying unit 125 specifies an irregular state signal.

For example, the specifying unit 125 calculates for each state signal, a difference between the subject signal value and the forecast signal value. The calculated difference is referred to as an “error”. The specifying unit 125 compares the error of each sate signal with a threshold value. The threshold value is predetermined. Then, the specifying unit 125 specifies the irregular state signal based on the comparison result. The state signal corresponding to the error larger than the threshold value is the irregular state signal.

In step S270, the displaying unit 126 generates a detection result based on a determination result in step S250 and a specification result in step S260, and displays the detection result on a display.

The detection result indicates the state of the subject system 220. Further, if the state of the subject system 220 is irregular, the detection result indicates the irregular state signal. For example, the detection result indicates the signal values of the irregular state signal in a chronological order and the forecast signal values of the irregular state signal.

Supplementary descriptions of the conversion from the multi-valued signal into the binary signal will be given.

It is considered that when operation or a state of a device of a facility changes, the signal is likely to be switched from a constant state, an increasing (rising) state, or a decreasing (lowering) state to another state. By setting each threshold value so that the state change point is included between the threshold values, it is possible to convert the multi-valued signal into the binary signal in such a way that the state of the signal changes according to transition of the operation of the facility and transition of the state of the facility.

### Effect of First Embodiment

It is possible to determine whether or not there is irregular operation in the facility, taking into consideration, a relation between a plurality of signals including the binary signal and the multi-valued signal. Further, since the multi-valued signal is converted into the binary signal, it is possible to calculate a degree of the irregularity in the binary signal and the multi-valued signal, using the same method.

The learned model is used which forecasts the next signal value based on the regular signal data in the chronological order. Thereby, it is possible to construct an irregularity detection apparatus which is input only the regular operation data of a factory line. Then, it is possible to detect various and unknown irregularities. Further, the multi-valued signal is converted into the binary signal, and the converted binary signal and another binary signal are combined with each other and learned. Therefore, it is possible to detect the irregularity, taking the relation between the plurality of signals into consideration.

### Second Embodiment

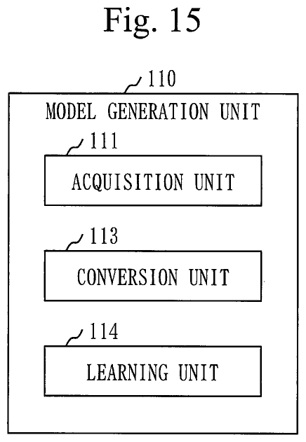

As to an embodiment of converting the multi-valued-signal value into the binary-signal value without using the threshold-value group, mainly matters different from the first embodiment will be described based on FIGS. 15 to 21.

***Description of Configuration***

A configuration of the irregularity detection system 200 is the same as the configuration in the first embodiment (see FIG. 1).

A configuration of the irregularity detection apparatus 100 is the same as the configuration in the first embodiment (see FIG. 2).

Based on FIG. 15, a configuration of the model generation unit 110 will be described.

The model generation unit 110 includes the acquisition unit 111, the conversion unit 113, and the learning unit 114. The threshold-value-group calculation unit 112 is unnecessary.

A configuration of the irregularity detection unit 120 is the same as the configuration in the first embodiment (see FIG. 4).

***Description of Operation***

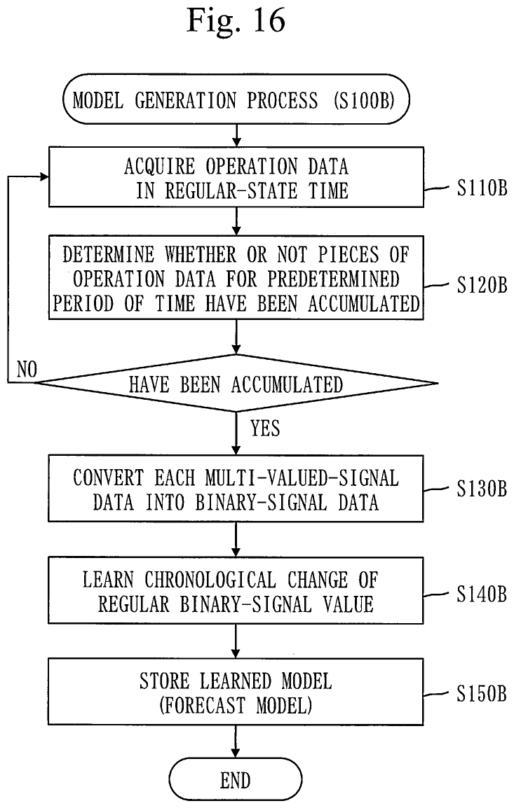

Based on FIG. 16, a model generation process (S100B) will be described.

The model generation process (S100B) is equivalent to the model generation process (S100) in the first embodiment.

In step S110B, the acquisition unit 111 acquires the operation data in the regular-state time and stores the acquired operation data in the storage unit 190.

Step S110B is the same as step S110 (see FIG. 6).

In step S120B, the acquisition unit 111 determines whether or not pieces of operation data in the regular-state time for a predetermined period of time have been accumulated.

Step S120B is the same as step S120 (see FIG. 6).

If the pieces of operation data for the predetermined period of time have been accumulated, the process proceeds to step S130B.

If the pieces of operation data for the predetermined period of time have not been accumulated, the process proceeds to step S110B.

In step S130B, the conversion unit 113 converts each multi-valued-signal data into the binary-signal data.

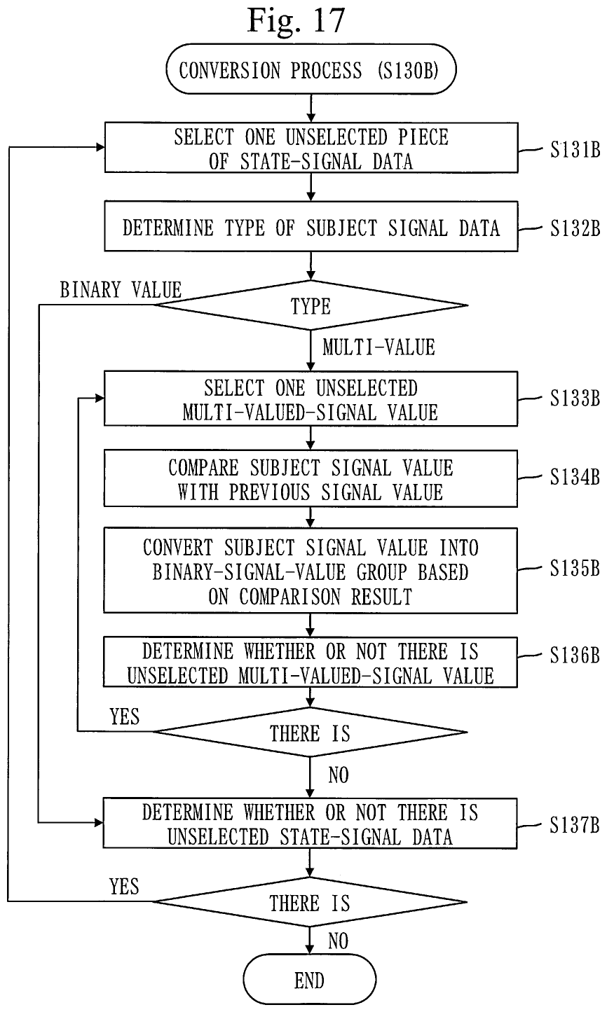

Based on FIG. 17, a procedure of a conversion process (S130B) will be described.

In step S131B, the conversion unit 113 selects one unselected piece of state-signal data from the operation database 198. The selected piece of state-signal data is referred to as “subject signal data”. The state signal corresponding to the subject signal data is referred to as a “subject signal”.

In step S132B, the conversion unit 113 determines a type of the subject signal data. A determination method is the same as the method in step S132 (see FIG. 7).

If the subject signal data is the binary-signal data, the process proceeds to step S137B.

If the subject signal data is the multi-valued-signal data, the process proceeds to step S133B.

In step S133B, the conversion unit 113 selects one unselected multi-valued-signal value from the subject signal data.

The selected multi-valued-signal value is referred to as a “subject signal value”. A time point corresponding to the subject signal value is referred to as a “subject time point”. The subject signal value is the multi-valued-signal value at the subject time point.

In step S134B, the conversion unit 113 extracts from the subject signal data, the multi-valued-signal value at a time point before the subject time point. It is presumed that the multi-valued-signal value at the time point before the subject time point has been left in the subject signal data. The extracted multi-valued-signal value is referred to as a “previous signal value”.

The conversion unit 113 compares the subject signal value with the previous signal value.

In step S135B, the conversion unit 113 converts the subject signal value into the binary-signal-value group based on the comparison result. However, also after the subject signal value is converted into the binary-signal-value group, the original subject signal value is left in the subject signal data.

Specifically, the conversion unit 113 determines a change tendency of the subject signal based on the comparison result, and converts the subject signal value into the binary-signal-value group based on the determination result. That is, the conversion unit 113 converts the subject signal value into the binary-signal-value group which indicates the change tendency of the subject signal.

Details of step S135B will be described later.

In step S136B, the conversion unit 113 determines whether or not there is an unselected multi-valued-signal value in the subject signal data.

If there is the unselected multi-valued-signal value, the process proceeds to step S133B.

If there is no unselected multi-valued-signal value, the process proceeds to step S137B.

In step S137B, the conversion unit 113 determines whether or not there is unselected state-signal data in the operation database 198.

If there is the unselected state-signal data, the process proceeds to step S131B.

If there is no unselected state-signal data, the process ends.

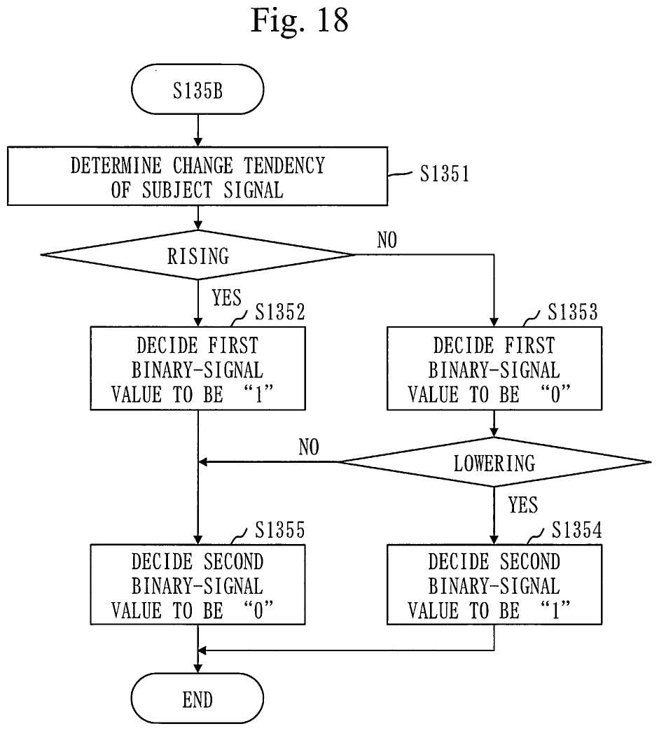

Based on FIG. 18, a procedure of step S135B in a case in which the subject signal value is converted into two binary-signal values will be described.

In step S1351, the conversion unit 113 determines the change tendency of the subject signal based on the comparison result.

If the subject signal value is larger than the previous signal value and an absolute value of a difference between the subject signal value and the previous signal value is larger than a threshold value, the subject signal is in a rising tendency.

If the subject signal value is smaller than the previous signal value and the absolute value of the difference between the subject signal value and the previous signal value is larger than the threshold value, the subject signal is in a lowering tendency.

If the subject signal is in the rising tendency, the process proceeds to step S1352.

If the subject signal is not in the rising tendency, the process proceeds to step S1353.

The conversion unit 113 may differentiate the subject signal value and determine the change tendency of the subject signal based on a differential value. The differentiation may be executed to any degree.

If a sign of the differential value is plus, the subject signal is in the rising tendency.

If the sign of the differential value is minus, the subject signal is in the lowering tendency.

In step S1352, the conversion unit 113 decides a first binary-signal value to be “1”.

After step S1352, the process proceeds to step S1355.

In step S1353, the conversion unit 113 decides the first binary-signal value to be “0”.

If the subject signal is in the lowering tendency, the process proceeds to step S1354.

If the subject signal is not in the lowering tendency, the process proceeds to step S1355.

In step S1354, the conversion unit 113 decides a second binary-signal value to be “1”.

After step S1354, the process ends.

In step S1355, the conversion unit 113 decides the second binary-signal value to be “0”.

After step S1355, the process ends.

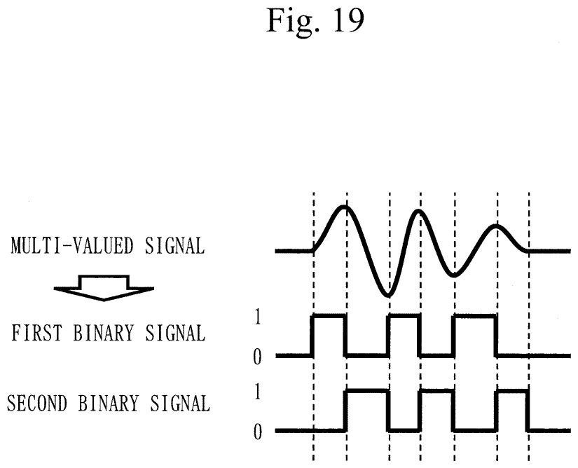

Based on FIG. 19, a conversion method in step S135B will be described.

The multi-valued signal is the subject signal, and the signal value, at each time point, of the multi-valued signal is the subject signal value.

In a first binary signal, the binary-signal value at each time point indicates by two values, whether or not the subject signal is in the rising tendency at each time point.

In a second binary signal, the binary-signal value at each time point indicates by two values, whether or not the subject signal is in the lowering tendency at each time point.

When the subject signal is in the rising tendency, the conversion unit 113 decides the first binary-signal value corresponding to the subject signal value, to be “1”. When the subject signal is not in the rising tendency, the conversion unit 113 decides the first binary-signal value corresponding to the subject signal value, to be “0”.

When the subject signal is in the lowering tendency, the conversion unit 113 decides the second binary-signal value corresponding to the subject signal value, to be “1”. When the subject signal is not in the lowering tendency, the conversion unit 113 decides the second binary-signal value corresponding to the subject signal value, to be “0”.

When both the first binary-signal value and the second binary-signal value are “0”, the subject signal is in a tendency that the signal value is constant.

Returning to FIG. 16, the descriptions will be continued from step S140B.

Each piece of binary-signal data accumulated in step S110B is referred to as “collected binary-signal data”. Each binary-signal value in the collected binary-signal data is referred to as a “collected binary-signal value”.

Each piece of binary-signal data acquired in step S130B is referred to as “converted binary-signal data”. Each binary-signal value in the converted binary-signal data is referred to as a “converted binary-signal value”.

A collection of the collected binary-signal data and the converted binary-signal data is referred to as a “regular binary-signal-data group”. A collection of the collected binary-signal value and the converted binary-signal value is referred to as a “regular binary-signal-value group”.

In step S140B, the learning unit 114 learns a chronological change of the regular binary-signal value of each state signal with use of the regular binary-signal-data group as input, and generates the learned model.

Step S140B is the same as step S150 (see FIG. 6).

In step S150B, the learning unit 114 stores in the storage unit 190, the learned model generated. The learned model stored is the “forecast model 191”.

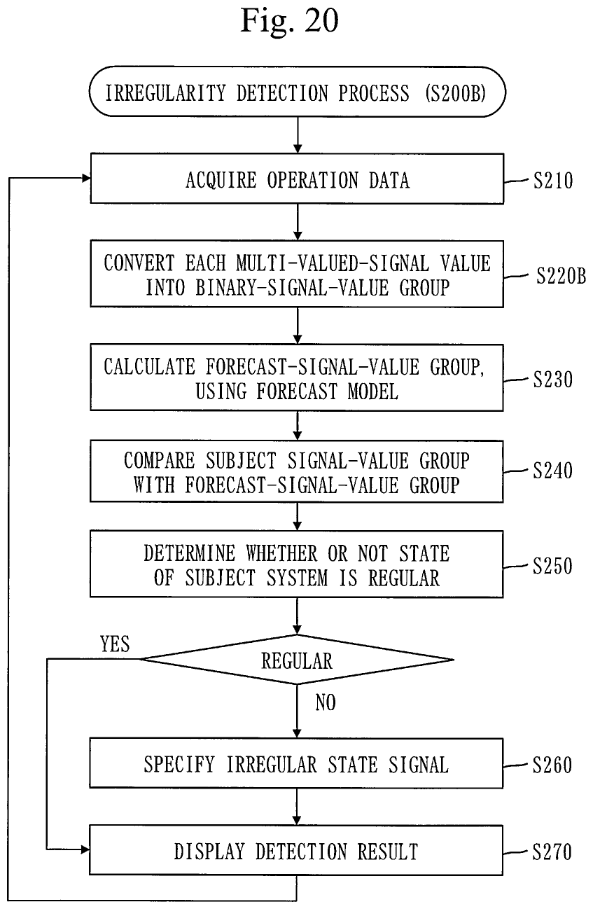

Based on FIG. 20, an irregularity detection process (S200B) will be described.

A process in each step other than step S220B is the same as the corresponding process in the first embodiment (see FIG. 13).

In step S220B, the forecast unit 123 reads the operation data at the subject time point from the operation database 199 and calls the conversion unit 122.

The conversion unit 122 converts each multi-valued-signal value in the operation data at the subject time point into the binary-signal-value group.

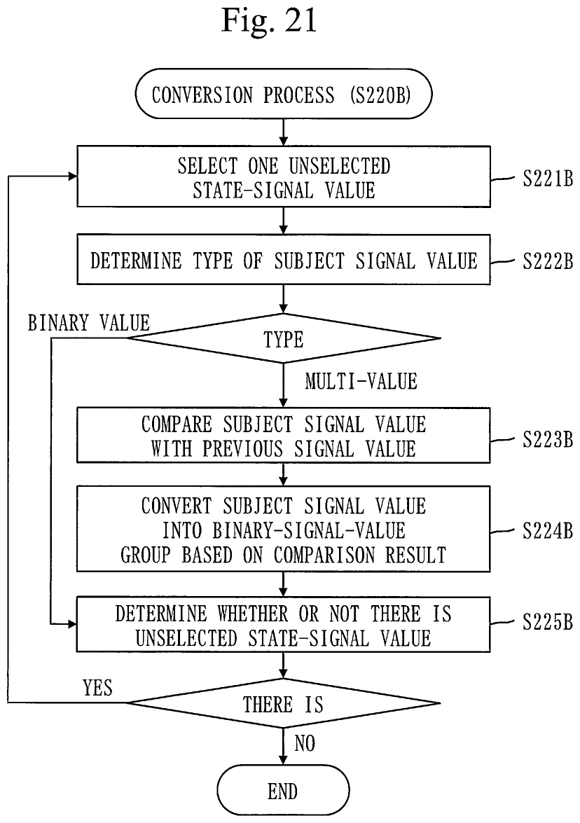

Based on FIG. 21, a conversion process (S220B) will be described.

In step S221B, the conversion unit 122 selects one unselected state-signal value from the operation data at the subject time point. The selected state-signal value is referred to as a “subject signal value”. The state-signal data corresponding to the subject signal value is referred to as “subject signal data.”

In step S222B, the conversion unit 122 determines a type of the subject signal value. A determination method is the same as the method in step S222 (see FIG. 14).

If the subject signal value is the binary-signal value, the process proceeds to step S225B.

If the subject signal value is the multi-valued-signal value, the process proceeds to step S223B.

In step S223B, the conversion unit 122 extracts from the subject signal data in the operation database 199, the multi-valued-signal value at a time point before the subject time point. It is presumed that the multi-valued-signal value at the time point before the subject time point has been left in the subject signal data. The extracted multi-valued-signal value is referred to as a “previous signal value”.

The conversion unit 122 compares the subject signal value with the previous signal value.

In step S224B, the conversion unit 122 converts the subject signal value into the binary-signal-value group based on a comparison result. However, also after the subject signal value is converted into the binary-signal-value group, the original subject signal value is left in the subject signal data.

A conversion method is the same as the method in step S135B (see FIG. 17).

In step S225B, the conversion unit 122 determines whether or not there is an unselected state-signal value in the operation data at the subject time point.

If there is the unselected state-signal value, the process proceeds to step S221B.

If there is no unselected state-signal value, the process ends.

Supplementary descriptions of the conversion from the multi-valued signal into the binary signal will be given.

A usual device which outputs the binary signal is set in such a way that the signal value changes according to transition of operation of a facility or transition of a state of the facility. For example, a sensor which detects a workpiece is set in such a way that the sensor becomes an on-state when moving of the workpiece is completed. Also, in a case where the multi-valued signal is converted into the binary signal, the multi-valued signal should be converted into the binary signal in such a way that the state changes according to the transition of the operation of the facility or the transition of the state of the facility.

It is considered that when the operation or the state of the facility changes, the multi-valued signal is likely to be switched from a constant state, an increasing (rising) state, or a decreasing (lowering) state to a different state. The multi-valued signal is converted into an increase binary signal (the first binary signal) and a decrease binary signal (the second binary signal), and consequently, the signal value of the binary signal changes at the state change point of the multi-valued signal. That is, it is possible to convert the multi-valued signal into the binary signal in such a way that the state changes according to the transition of the operation of the facility and the transition of the state of the facility.

Further, not only the signal value of the multi-valued signal is converted into the signal value of the increase binary signal and the signal value of the decrease binary signal but also a differential value of the signal value of the multi-valued signal may be converted into the signal value of the increase binary signal and the signal value of the decrease binary signal. It is considered that the differential value of the signal value increases or decreases when the operation or the state of the facility changes. By converting the differential value of the signal value into the signal value of the increase binary signal and the signal value of the decrease binary signal, it is possible to recognize a change in the operation of the facility and a change in the state of the facility.

### Effect of Second Embodiment

It is possible to acquire the same effect as the first embodiment, converting the multi-valued-signal value into the binary-signal value without using the threshold-value group.

### Supplement to Embodiments

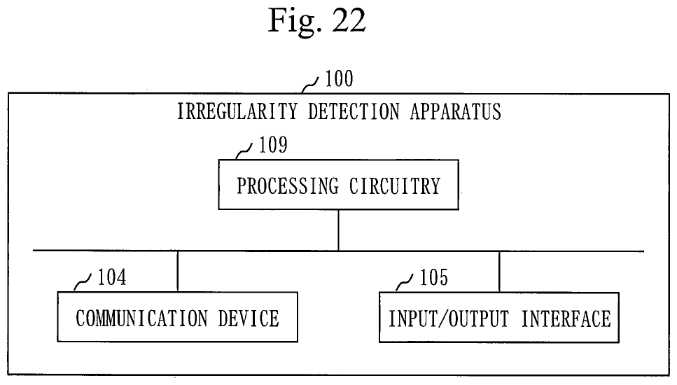

Based on FIG. 22, a hardware configuration of the irregularity detection apparatus 100 will be described.

The irregularity detection apparatus 100 includes processing circuitry 109.

The processing circuitry 109 is hardware that realizes the model generation unit 110 and the irregularity detection unit 120.

The processing circuitry 109 may be dedicated hardware or the processor 101 that executes a program stored in the memory 102.

When the processing circuitry 109 is the dedicated hardware, the processing circuitry 109 is, for example, a single circuit, a composite circuit, a programmed processor, a parallel-programmed processor, an ASIC, an FPGA, or a combination of these.

ASIC stands for Application Specific Integrated Circuit.

FPGA stands for Field Programmable Gate Array.

The irregularity detection apparatus 100 may include a plurality of pieces of processing circuitry that substitute for the processing circuitry 109. The plurality of pieces of processing circuitry share a function of the processing circuitry 109.

In the processing circuitry 109, a part of the function may be realized by the dedicated hardware, and the rest of the function may be realized by software or firmware.

In this way, the function of the irregularity detection apparatus 100 can be realized by hardware, software, firmware, or a combination of these.

Each embodiment is an example of a preferred embodiment, and is not intended to limit the technical scope of the present disclosure. Each embodiment may be implemented partially or implemented being combined with the other embodiment.

The procedures described using the flowcharts and the like may be modified as necessary.

“unit” which is an element of the irregularity detection apparatus 100 may be replaced by “process” or “step”.

### REFERENCE SIGNS LIST

100: irregularity detection apparatus, 101: processor, 102: memory, 103: storage, 104: communication device, 105: input/output interface, 109: processing circuitry, 110: model generation unit, 111: acquisition unit, 112: threshold-value-group calculation unit, 113: conversion unit, 114: learning unit, 120: irregularity detection unit, 121: acquisition unit, 122: conversion unit, 123: forecast unit, 124: determination unit, 125: specifying unit, 126: displaying unit, 190: storage unit, 191: forecast model, 192: threshold-value-group database, 198: operation database, 199: operation database, 200: irregularity detection system, 201: network, 202: network, 210: data collection server, 220: subject system, 221: facility.

1. An irregularity detection system for detecting irregularity of a subject system based on a binary-signal value of each of one or more binary signals and a multi-valued-signal value of each of one or more multi-valued signals, the irregularity detection system comprising:
processing circuitry
to convert the multi-valued-signal value of each of the one or more multi-valued-signals at each time point into a binary-signal-value group which is one or more binary-signal values;
to calculate a forecast-signal-value group at a subject time point by computing a forecast model with use of, as input, a past-signal-value group which is a collection of the binary-signal value of each of the one or more binary signals at each time point before the subject time point and the binary-signal-value group of each of the one or more multi-valued signals at each time point before the subject time point; and
to compare with the forecast-signal-value group, a subject signal-value group which is a collection of the binary-signal value of each of the one or more binary signals at the subject time point and the binary-signal-value group of each of the one or more multi-valued signals at the subject time point, and determine whether or not a state of the subject system at the subject time point is regular, based on a comparison result.

2. The irregularity detection system according to claim 1,
wherein the processing circuitry compares a multi-valued-signal value of a multi-valued signal at each time point with each of one or more threshold values which are for the multi-valued-signal, and converts for each threshold value, the multi-valued-signal value into a binary-signal value which indicates by two values, a magnitude-comparison relation between the multi-valued-signal value and the threshold value.

3. The irregularity detection system according to claim 2,
wherein the processing circuitry extracts a multi-valued-signal value of each of one or more state change points which are time points at which a change tendency of the multi-valued signal changes, from multi-valued-signal data including the multi-valued-signal value of the multi-valued signal at each time point at a time when the state of the subject system is regular, generates a frequency distribution of the extracted multi-valued-signal value, and calculates one or more threshold values which are for the multi-valued signal, based on the generated frequency distribution.

4. The irregularity detection system according to claim 3,
wherein the processing circuitry calculates for each area between peaks of the frequency distribution, a value between a multi-valued-signal value corresponding to one peak and a multi-valued-signal value corresponding to the other peak, as the threshold value which is for the multi-valued signal.

5. The irregularity detection system according to claim 1,
wherein the processing circuitry compares a subject signal value which is a multi-valued-signal value of a multi-valued signal at each time point, with a multi-valued-signal value at a time point before each time point, determines a change tendency of the multi-valued signal at each time point based on a comparison result, and converts the subject signal value into one or more binary-signal values which indicate by two values, the change tendency of the multi-valued signal.

6. The irregularity detection system according to claim 5,
wherein the processing circuitry converts the subject-signal value into a binary-signal value which indicates by two values, whether or not the multi-valued signal is in a rising tendency, and a binary-signal value which indicates by two values, whether or not the multi-valued signal is in a lowering tendency.

7. The irregularity detection system according to claim 1,
wherein the processing circuitry generates a learned model used as the forecast model, with use of, as input, collected binary-signal data including the binary-signal value of each of the one or more binary signals at each time point at a time when the state of the subject system is regular, and converted binary-signal data including the binary-signal-value group of each of the one or more multi-valued signals at each time point at a time when the state of the subject system is regular, learning a chronological change of the binary-signal value of each binary signal and a chronological change of the binary-signal-value group of each multi-valued signal.

8. An irregularity detection method for detecting irregularity of a subject system based on a binary-signal value of each of one or more binary signals and a multi-valued-signal value of each of one or more multi-valued signals, the irregularity detection method comprising:
converting the multi-valued-signal value of each of the one or more multi-valued-signals at each time point into a binary-signal-value group which is one or more binary-signal values;
calculating a forecast-signal-value group at a subject time point by computing a forecast model with use of, as input, a past-signal-value group which is a collection of the binary-signal value of each of the one or more binary signals at each time point before the subject time point and the binary-signal-value group of each of the one or more multi-valued signals at each time point before the subject time point; and
comparing with the forecast-signal-value group, a subject signal-value group which is a collection of the binary-signal value of each of the one or more binary signals at the subject time point and the binary-signal-value group of each of the one or more multi-valued signals at the subject time point, and determining whether or not a state of the subject system at the subject time point is regular, based on a comparison result.

9. A non-transitory computer readable medium storing an irregularity detection program for detecting irregularity of a subject system based on a binary-signal value of each of one or more binary signals and a multi-valued-signal value of each of one or more multi-valued signals, the irregularity detection program which causes a computer to execute:
a conversion process of converting the multi-valued-signal value of each of the one or more multi-valued-signals at each time point into a binary-signal-value group which is one or more binary-signal values;
a forecast process of calculating a forecast-signal-value group at a subject time point by computing a forecast model with use of, as input, a past-signal-value group which is a collection of the binary-signal value of each of the one or more binary signals at each time point before the subject time point and the binary-signal-value group of each of the one or more multi-valued signals at each time point before the subject time point; and
a determination process of comparing with the forecast-signal-value group, a subject signal-value group which is a collection of the binary-signal value of each of the one or more binary signals at the subject time point and the binary-signal-value group of each of the one or more multi-valued signals at the subject time point, and determining whether or not a state of the subject system at the subject time point is regular, based on a comparison result.

10. The irregularity detection system according to claim 2,
wherein the processing circuitry generates a learned model used as the forecast model, with use of, as input, collected binary-signal data including the binary-signal value of each of the one or more binary signals at each time point at a time when the state of the subject system is regular, and converted binary-signal data including the binary-signal-value group of each of the one or more multi-valued signals at each time point at a time when the state of the subject system is regular, learning a chronological change of the binary-signal value of each binary signal and a chronological change of the binary-signal-value group of each multi-valued signal.

11. The irregularity detection system according to claim 3,
wherein the processing circuitry generates a learned model used as the forecast model, with use of, as input, collected binary-signal data including the binary-signal value of each of the one or more binary signals at each time point at a time when the state of the subject system is regular, and converted binary-signal data including the binary-signal-value group of each of the one or more multi-valued signals at each time point at a time when the state of the subject system is regular, learning a chronological change of the binary-signal value of each binary signal and a chronological change of the binary-signal-value group of each multi-valued signal.

12. The irregularity detection system according to claim 4,
wherein the processing circuitry generates a learned model used as the forecast model, with use of, as input, collected binary-signal data including the binary-signal value of each of the one or more binary signals at each time point at a time when the state of the subject system is regular, and converted binary-signal data including the binary-signal-value group of each of the one or more multi-valued signals at each time point at a time when the state of the subject system is regular, learning a chronological change of the binary-signal value of each binary signal and a chronological change of the binary-signal-value group of each multi-valued signal.

13. The irregularity detection system according to claim 5,
wherein the processing circuitry generates a learned model used as the forecast model, with use of, as input, collected binary-signal data including the binary-signal value of each of the one or more binary signals at each time point at a time when the state of the subject system is regular, and converted binary-signal data including the binary-signal-value group of each of the one or more multi-valued signals at each time point at a time when the state of the subject system is regular, learning a chronological change of the binary-signal value of each binary signal and a chronological change of the binary-signal-value group of each multi-valued signal.

14. The irregularity detection system according to claim 6,
wherein the processing circuitry generates a learned model used as the forecast model, with use of, as input, collected binary-signal data including the binary-signal value of each of the one or more binary signals at each time point at a time when the state of the subject system is regular, and converted binary-signal data including the binary-signal-value group of each of the one or more multi-valued signals at each time point at a time when the state of the subject system is regular, learning a chronological change of the binary-signal value of each binary signal and a chronological change of the binary-signal-value group of each multi-valued signal.
